(19) United States
(12) Patent Application Publication
(10) Pub. No.: US 2024/0264783 A1
(43) Pub. Date: Aug. 8, 2024

(54) PRINTING SYSTEM, PROCESSING IMAGE PRODUCTION METHOD, AND PRINT PRODUCTION METHOD

(71) Applicant: SEIKO EPSON CORPORATION, Tokyo (JP)

(72) Inventors: Kento KOBAYASHI, Shiojiri (JP); Akio TAKAMOTO, Shiojiri (JP)

(21) Appl. No.: 18/427,926

(22) Filed: Jan. 31, 2024

(30) Foreign Application Priority Data
Feb. 2, 2023 (JP) 2023-014457

(51) Int. Cl. G06F 3/12; G06K 15/02

(52) U.S. Cl. CPC G06F 3/1245; G06F 3/1206; G06F 3/1243; G06K 15/1898

(57) ABSTRACT

A printing system receives a print image to be printed and an operation instruction, generates a processing image obtained by adding an instruction image corresponding to the operation instruction to the print image, receives the processing image and converts the processing image into a processing job, receives the processing job, discriminates the instruction image from an image of the processing job, and operates according to the operation instruction corresponding to the instruction image to cause a printing unit to print the print image.

The present application is based on, and claims priority from JP Application Serial Number 2023-014457, filed Feb. 2, 2023, the disclosure of which is hereby incorporated by reference herein in its entirety.

### BACKGROUND

### 1. Technical Field

The present disclosure relates to a printing system, a processing image production method, and a print production method.

### 2. Related Art

There has been known a printer driver that adds, to image data for printing, separately from a print image, a cutting command for instructing to cut paper (for example, JP-A-2019-192052 (Patent Literature 1)).

However, when printing is performed using a printer driver (for example, a standard printer driver of an OS) not adapted to all functions of a printer, printing using a part of the functions of the printer cannot be performed.

### SUMMARY

A printing system for solving the problem described above includes: a generation computer configured to receive a print image to be printed and an operation instruction and generate a processing image obtained by adding an instruction image corresponding to the operation instruction to the print image; a conversion computer configured to receive the processing image and convert the processing image into a processing job; and a printing control computer configured to receive the processing job, discriminate the instruction image from an image of the processing job, and operate according to the operation instruction corresponding to the instruction image to cause a printing unit to print the print image.

A processing image production method for solving the problem described above includes: receiving a print image to be printed and an operation instruction; and generating a processing image obtained by adding an instruction image corresponding to the operation instruction to the print image.

A print production method for solving the problem described above includes: receiving a processing image obtained by adding an instruction image corresponding to an operation instruction to a print image; discriminating the instruction image from the processing image; and operating according to the operation instruction corresponding to the instruction image to cause a printing unit to print the print image.

### BRIEF DESCRIPTION OF THE DRAWINGS

FIG. 1 is a block diagram of a printing system.

FIG. 2 is a block diagram of a user terminal.

FIG. 3 is a block diagram of a printer.

FIG. 4 is a sequence chart of a template registration sequence.

FIG. 5 is a diagram showing an editing screen example of a receipt application.

FIG. 6 is a sequence chart of a printing sequence.

FIG. 7 is a diagram showing an example of an instruction image in another embodiment.

FIG. 8 is a diagram showing an example of an instruction image in another embodiment.

### DESCRIPTION OF EMBODIMENTS

Embodiments of the present disclosure are explained below according to the following order.

(1) Configuration of a printing system
(1-1) Configuration of a user terminal
(1-2) Configuration of a printer
(2) Receipt printing sequence
(2-1) Template registration sequence
(2-2) Printing sequence
(3) Other embodiments

### (1) Configuration of a Printing System

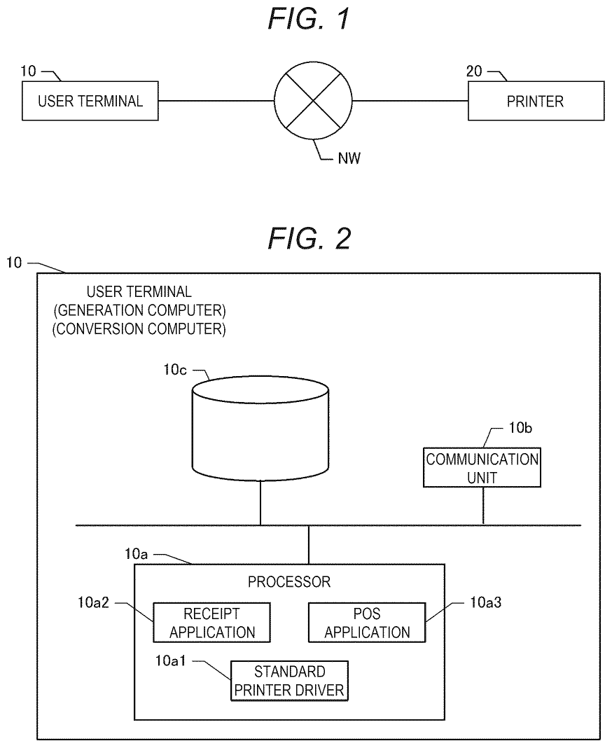

FIG. 1 is a diagram showing an example of a printing system according to an embodiment of the present disclosure. In this embodiment, the printing system is implemented by a user terminal 10 and a printer 20. The user terminal 10 is connected to the printer 20 via a network NW. The user terminal 10 is capable of communicating with the printer 20 and exchanging various kinds of information. A form of the network NW is not limited and may be the Internet or may be a LAN (Local Area Network). Both of the Internet and the LAN may be used. Naturally, the user terminal 10 and the printer 20 may be directly connected by a cable or may be directly connected by radio.

In this embodiment, the printer 20 is a so-called receipt printer. The user terminal 10 is a terminal that generates content to be printed as a receipt and outputs the content to the printer 20 to cause the printer 20 to execute printing. A user can operate the user terminal 10 and edit a template of the receipt. In this embodiment, the user terminal 10 functions as a POS terminal as well. That is, by acquiring purchase data of a customer, extracting items to be printed on the receipt from the purchase data, and generating an image in which the items are arranged in the template and outputting the image to the printer 20, the user terminal 10 can cause the printer 20 to print the receipt in which the purchase data is added to the template.

In the user terminal 10, a printer driver is used in order to cause the printer 20 to perform printing. That is, when the user instructs printing of content using an application program, data indicating the content is delivered to the printer driver. The user terminal 10 generates, with a function of the printer driver, printing data for printing the content according to setting designated by the user.

As the printer driver, there are a printer-specific printer driver prepared by a vendor of the printer and a standard printer driver included in an operating system (OS) for causing the user terminal 10 to operate. In this embodiment, if the printer-specific printer driver is used, all functions executable by the printer can be used. On the other hand, the standard printer driver is a part of a module of the OS. The standard printer driver is also installed when the OS is installed in the user terminal 10. When the standard printer driver is used, printing data printable by printers of a plurality of models provided by a plurality of vendors can be generated. Therefore, if the standard printer driver is used, printing can be performed by various printers even if the printer-specific printer driver is not installed.

In this embodiment, a state is assumed in which the printer-specific printer driver is not installed in the user terminal 10 and the OS includes the standard printer driver. In such the user terminal 10, printing can be performed by various printers if the standard printer driver is used. However, since the standard printer driver supports only functions usable in common in a plurality of printers, specific functions in a specific printer sometimes cannot be used. Specifically, a printing control command specific to a receipt printer cannot be used. Therefore, in this embodiment, the user terminal 10 and the printer 20 are configured to make it possible to give the same operation instruction as a printer-specific printing control command to the printer 20 even when causing the printer 20 to perform printing using the standard printer driver.

The devices configuring the printing system explained above are explained below.

### (1-1) Configuration of the User Terminal

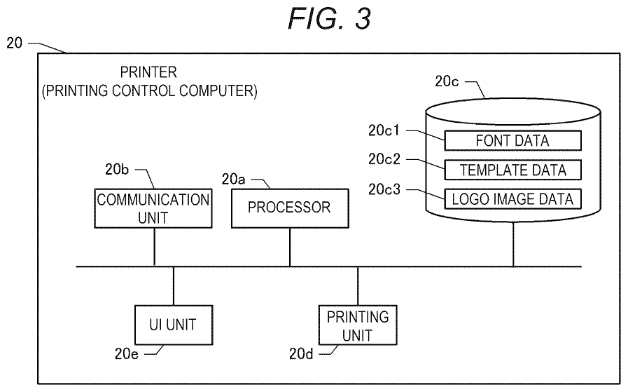

FIG. 2 is a block diagram showing a configuration of the user terminal 10. The user terminal 10 includes a processor 10a, a communication unit 10b, a nonvolatile memory 10c, a display 10d, and an input unit 10e. The processor 10a includes a CPU, a ROM, and a RAM not shown in FIG. 2. The processor 10a can execute various programs recorded in the nonvolatile memory 10c and control the units of the user terminal 10.

The communication unit 10b includes a communication interface for communicating with external equipment according to various communication protocols. The user terminal 10 is capable of communicating with the printer 20 via the communication unit 10b. The communication unit 10b includes an interface for communicating with various removable memories attached to the user terminal 10.

The display 10d is a display device that displays any image. The input unit 10e is a device with which the user performs input operation and is configured by, for example, a keyboard and a mouse. In this embodiment, it is assumed that the user terminal 10 is a stationary terminal. However, naturally, the user terminal 10 may be a terminal of another form. For example, the user terminal 10 may be a tablet terminal, a smartphone terminal, or the like. When the user terminal 10 is the other terminal such as the tablet terminal or the smartphone terminal, the input unit 10e may be configured by a touch panel or the like. In any case, the user can operate the input unit 10e and input intention of the user while visually recognizing images and characters displayed on the display 10d.

When the user terminal 10 is started, a not-shown OS stored in the nonvolatile memory 10c is executed. Various functions such as communication and data storage in the user terminal 10 are executed using the OS. In this embodiment, a printing function is included in functions executable using the OS. That is, the OS according to this embodiment includes a standard printer driver 10a1. The user terminal 10 is capable of executing a receipt preparing application program (hereinafter referred to as receipt application 10a2) and a POS application program (hereinafter referred to as POS application 10a3) stored in the nonvolatile memory 10c while using the functions of the OS.

Under the execution of the receipt application 10a2, the user can operate the input unit 10e to design a print image to be printed as a receipt, a coupon, or the like and input an operation instruction to the printer 20. The print image means an image to be printed and includes characters and signs to be printed. In this embodiment, the input of the operation instruction is performed by arranging, in the print image, an icon, a frame, and an image (referred to as instruction image) represented by a two-dimensional code, a barcode, or the like. The processor 10a executing the receipt application 10a2 receives the print image and the operation instruction and generates a processing image obtained by adding the instruction image corresponding to the operation instruction to the print image. In this case, the processor 10a of the user terminal 10 functions as a generation computer.

The user selects a printing button provided by the receipt application 10a2 to control the display 10d with the function of the standard printer driver 10a1 to display an input screen for print setting. The user operates the input unit 10e to input the print setting and performs a printing instruction. When the printing instruction is performed, the processor 10a generates, with the function of the standard printer driver 10a1, a processing job for performing printing according to the input setting.

Under the execution of the receipt application 10a2, when the user operates the input unit 10e to input a print instruction, a processing image is received and converted into a processing job by the function of the standard printer driver 10a1 and output to the printer 20. The processing job includes printing setting data and an image into which the processing image is converted by being rendered based on the printing setting data. In this case, the processor 10a of the user terminal 10 functions as a conversion computer.

As explained above, the user terminal 10 according to this embodiment can cause, with the function of the standard printer driver 10a1, the printer 20 to execute printing. The printing by the standard printer driver 10a1 is printing performed not using a printer driver specific to the printer 20. In the case of printing by the printer driver specific to the printer 20, the specific printer driver has a function of adding a specific (nonstandard) printing control command to a processing job other than the standard printing control command. Note that the specific printing control command in the specific printer driver is not an operation instruction by an instruction image. The standard printer driver 10a1 does not have a function of adding a nonstandard operation instruction, which the specific printer driver can add as a command, to the processing job as a command.

### (1-2) Configuration of the Printer

FIG. 3 is a block diagram showing a configuration of the printer 20. The printer 20 includes a processor 20a, a communication unit 20b, a nonvolatile memory 20c, a printing unit 20d, and a UI unit 20e. The processor 20a includes a CPU, a ROM, and a RAM not shown in FIG. 3. The processor 20a can execute various programs recorded in the nonvolatile memory 20c and controls the units of the printer 20.

Note that the processor 20a may be configured by a single chip, may be configured by a plurality of chips, or may be configured as an SoC together with various functional blocks. For example, an ASIC may be adopted instead of the CPU or the CPU and the ASIC may cooperate. When the devices in this embodiment include processors, the processors can be implemented in various forms like the processor 20a.

The communication unit 20b includes a communication interface for communicating with external equipment according to various communication protocols. The printer 20 is capable of communication with the other devices via the communication unit 20b. Note that the communication unit 20b may include an interface for communicating with various peripheral devices attached to the printer 20. In this embodiment, peripheral devices such as a cash drawer, a handy scanner, a speaker, and a customer display are connected to the printer 20 by the communication unit 20b. The processor 20a can control the peripheral devices through the communication unit 20b.

The printing unit 20d is a part that executes printing. The printing unit 20d prints content on a printing medium. In this embodiment, since the printer 20 is assumed to be a receipt printer, a printing scheme in the printing unit 20d is assumed to be a thermal type and a printing medium is assumed to be roll paper. Content to be printed is assumed to be a receipt, a coupon, and the like at the time of commodity purchase. In other embodiments, various schemes such as an inkjet scheme, a toner scheme, and a sublimation scheme can be adopted as the printing scheme. The printing medium may be cut paper and may be various printing media without being limited to the printing paper. The printing unit 20d includes an actuator, various devices, a sensor, a driving circuit, and mechanical components for executing printing on a printing medium. The printing unit 20d may be configured to be capable of implementing various functions concerning printing. In this embodiment, the printing unit 20d includes a cut mechanism that cuts printed roll paper.

The UI unit 20e includes buttons and an LED. The buttons include various buttons including a power button. The processor 20a can specify a button operated by the user. The processor 20a lights or flashes the LED to indicate a status or the like of the printer 20.

Various data are stored in the nonvolatile memory 20c. For example, font data 20c1 for a receipt, template data 20c2 of the receipt, and logo image data 20c3 of a store are recorded in the nonvolatile memory 20c.

In this embodiment, when receiving, via the communication unit 20b, a processing job transmitted from the user terminal 10, first, the processor 20a of the printer 20 analyzes, with template matching, whether an instruction image is included in an image included in the processing job. When the instruction image is included, the processor 20a operates according to an operation instruction corresponding to the instruction image and causes the printing unit to print a print image. In this case, the processor 20a of the printer 20 functions as a printing control computer.

### (2) Receipt Printing Sequence

Subsequently, a receipt printing sequence is explained. In this embodiment, the receipt printing sequence is divided into a template registration sequence for creating and registering a template of a receipt and a printing sequence for inserting purchase data into the registered template and printing the receipt.

### (2-1) Template Registration Sequence

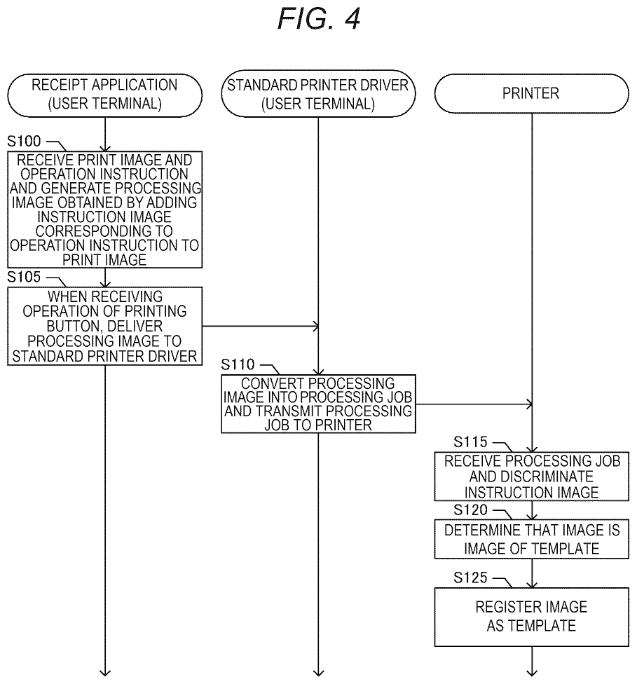

First, the template registration sequence is explained with reference to FIG. 4. The template registration sequence is started when the user operates the user terminal 10 and starts the receipt application 10a2. The processor 10a executes the receipt application 10a2 to thereby receive a print image and an operation instruction and generate a processing image obtained by adding an instruction image corresponding to the operation instruction to the print image (step S100).

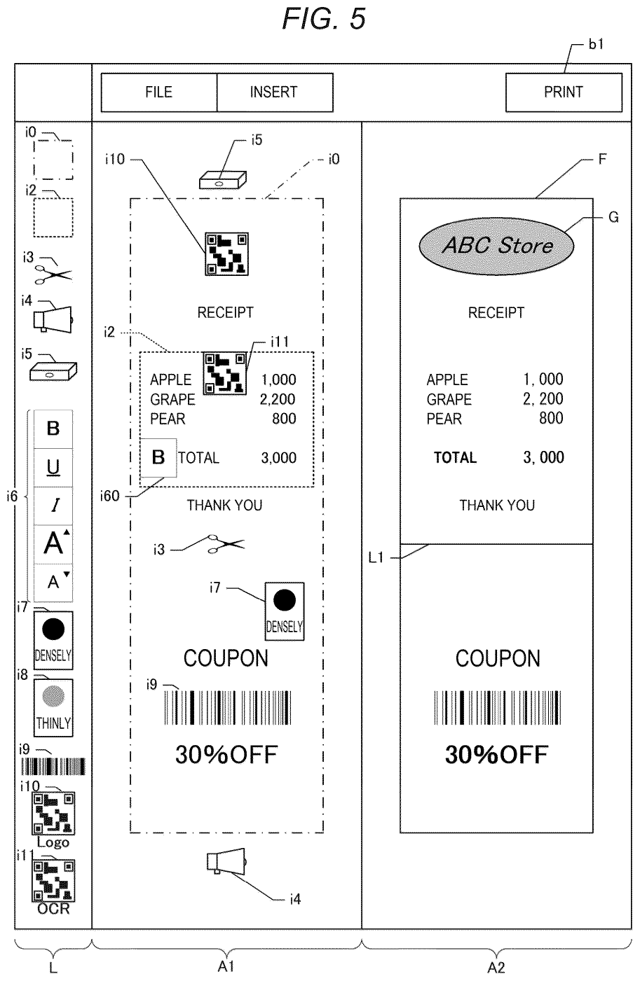

FIG. 5 is a diagram showing an example of an editing screen of the receipt application 10a2. The editing screen of the receipt application 10a2 includes an editing region A1, a preview region A2, and a list L. The editing region A1 is a region for editing content to be printed. The user can input characters to and arrange images and arrange any instruction image in the list L in the editing region A1. Instruction images listed in the list L correspond to operation instructions for the printer 20.

The instruction images listed in the list L can be arranged in positions in the editing region A1 by any operation such as click, tap, or drag. More specifically, the user is capable of arranging a desired instruction image in the list L in a desired position in the editing region A1 by clicking or tapping the desired instruction image and thereafter clicking or taping the desired position. The user can arrange a desired instruction image in the list L in a desired position in the editing region A1 by dragging the desired instruction image to the desired position. The preview region A2 is a region for displaying a preview of a print to be produced based on objects such as character strings, images, and an instruction image arranged in the editing region A1.

The instruction image includes a frame line of a predetermined type indicating a printing range. In this embodiment, a frame i0 indicated by an alternate long and short dash line is a frame indicating the printing range. The user drags the frame i0 from the list L to the editing region A1, adjusts longitudinal and lateral lengths of the frame i0, and arranges the frame i0 in the editing region A1. The processor 10a displays, in the preview region A2, a frame F having length corresponding to the length of the frame i0 arranged in the editing region A1. Note that, in this embodiment, the printer 20 is assumed to use, for example, roll paper having width of 80 mm or 58 mm as a printing medium. Printing is executed after sizes of the character strings and the images arranged in the frame i0 are enlarged or reduced in the printer 20 such that content in the frame i0 is fit within the lateral width of the roll paper set in the printer 20.

In this example, it is assumed that the content in the frame i0 is printed in order from the top to the bottom of the paper surface of FIG. 5. For example, when desiring to cause the printer 20 to perform operation for opening the cash drawer before printing the content in the frame i0, the user drags and arranges a drawer icon i5 on the outer side of the upper end of the frame i0 of the editing region A1. That is, the processor 10a generates a processing image obtained by adding an instruction image to a position corresponding to an operation instruction corresponding to the instruction image and displays the processing image in the editing region A1.

In this embodiment, content to be printed by the printer 20 includes a regular section and a variable section. In the variable section, for example, a date and names, prices, and the numbers of items of purchased commodities are for each of types of the purchased commodities are shown. The number of rows of the variable section can be different depending on, for example, the number of types of purchased commodities. In the content, a section other than the variable section is the regular section. The regular section is a portion where a regular word, logo, or the like is arranged.

The instruction image includes a barcode or a two-dimensional code. For example, when desiring to regularly print a logo of the store on a receipt, the user drags and arranges a logo insertion icon i10. The logo insertion icon i10 is a two-dimensional code. An operation instruction to insert a logo image of the store into a position where the logo insertion icon i10 is arranged is encoded. Since the logo insertion icon i10 is arranged in the editing region A1, the processor 10a displays, in a position in the preview region A2 corresponding to the position of the logo insertion icon i10 in the editing region A1, a logo image G associated in advance with the logo insertion icon i10. As shown in FIG. 5, character strings “Receipt”, “Thank you”, “Coupon”, and “30% off” are regularly-printed character strings in the receipt in this example. The user inputs a desired character string and arranges the character string in a desired position in the frame i0. The processor 10a displays these character strings in positions in the preview region A2 corresponding to the positions where the character strings are arranged.

The user arranges a frame i2 indicated by a broken line in a position where the user desires to provide the variable section. The frame i2 is arranged on the inner side of the frame i0 indicating a printing range. The frame i2 is a frame line of a type different from the frame i0. As explained below, the frame i2 and the frame i0 can be distinguished by the types of the frame lines when an image is analyzed on the printer 20 side. Note that the frames i0 and i2 may be different in colors of the lines or may be different in line types. The user arranged sample character strings in the frame i2.

An OCR icon i11 is an instruction image for instructing the printer 20 to perform an operation for subjecting a character to OCR conversion in the printer 20 to acquire a character code, deleting an image of the character, and replacing the image with the font data 20c1 incorporated in the printer 20 corresponding to the character code. For example, when desiring to give such an instruction to the character strings in the frame i2, the user arranges the OCR icon i11 in the frame i2. The processor 10a converts the character strings in the region where the OCR icon i11 is arranged into the same font data as the font data 20c1 incorporated in the printer 20 and displays the font data in the preview region A2. Note that the font data 20c1 incorporated in the printer 20 is data of a font designed to be a form easily read as a character printed on a printing medium for a receipt. If a character, which is a rendered image, transmitted from the user terminal 10 is enlarged or reduced according to the width of roll paper and printed, the character is likely to be a character that is less easily read on the receipt. Therefore, the OCR icon i11 is provided such that the operation instruction to subject the character, which is the rendered image, to OCR and replace the character with the incorporated font data 20c1 can be performed.

When desiring to change a format of a character in a row having a specific character string in the frame i2, the user selects a desired icon out of character format icons i6 in the list L and arranges the desired icon at the head of the row. FIG. 5 shows an example in which a bold character icon i60 is arranged in a row in which a character string “Total” is arranged. Since the bold character icon i60 is arranged in this way, the processor 20a displays, in the preview region A2, the row including the character string “Total” with bold characters thicker than characters in other rows and indicates that the row is printed with bold characters in actual printing as well.

The user arranges a scissors icon i3 in a cut position of roll paper in the frame i0 indicating the printing range of the editing region A1. According to the arrangement of the scissors icon i3, the processor 10a displays a line L1 indicating the cut position in a position of the preview region A2 corresponding to the scissors icon i3. In this embodiment, a region in the frame i0 is regarded as being divided by the cut. Icons i7 and i8 in the list L are instruction images corresponding to an operation instruction for changing printing concentration in the printer 20 from a default value. In FIG. 5, an example is shown in which the icon i7 indicating that the printing concentration is increased is arranged in the latter half region divided by the scissors icon i3. Since the icon i7 is arranged in the divided latter half region, the processor 20a displays character strings and images arranged in the latter half in the preview region A2 in a form indicating that the character strings and the images are printed at concentration higher than the default concentration. Note that, by printing s barcode and the like at high concentration, a reading failure ratio by a handy scanner can be reduced.

A barcode icon i9 is an instruction image for instructing to print a barcode in a position where the barcode icon i9 is arranged. For example, according to the arrangement of the barcode icon i9 in the editing region A1 by the user, the processor 20a displays a screen for inputting data to be encoded into a barcode, encodes the data input by the user to generate the barcode, and displays an image of the generated barcode in a position in the editing region A1 where the user arranged the barcode icon i9 and a position in the preview region A2 corresponding to the position. For example, when desiring to sound a buzzer after printing of the content in the frame i0 ends, the user arranges a buzzer icon i4 on the outer side of the lower end portion of the frame i0 of the editing region A1.

As explained above, in step S100, the processor 10a executes the receipt application 10a2 to thereby generate a processing image. In the case of the example shown in FIG. 5, the processing image is an image in the entire inside of the editing region A1. That is, an image including the buzzer icon i4 and the drawer icon i5 on the outer side of the frame i0 is treated as the processing image. Subsequently, when the user clicks or taps a printing button b1, the processor 10a receives operation of the printing button b1 and delivers the processing image to the standard printer driver 10a1 (step S105).

When receiving the processing image, the processor 10a, which executes the standard printer driver, converts the processing image into a processing job and transmits the processing job to the printer 20 (step S110). The conversion is conversion for generating a processing job from a processing image input as a mere raster image or vector image without considering what kind of a command an icon, a frame, or the like corresponds to. Accordingly, a processing job including a rendered processing image does not include a character code representing an icon, a command representing a function of the processing job, and the like. The conversion may include processing for converting a format of an image or may be processing for keeping the image as it is and adding a standard printing command to generate a processing job. That is, the processor 10a performs rendering according to the receipt application 10a2 and the standard printer driver 10a1 based on a character code of an icon designated by user operation on the receipt application 10a2, a command indicating the position of the icon, and the like and converts the processing image into a rendered processing image to generate a processing job. The processor 10a transmits the processing job including the processing image and an instruction to print the processing image to the printer 20 via the communication unit 10b.

Subsequently, when receiving the processing job via the communication unit 20b, the processor 20a of the printer 20 discriminates an instruction image from an image included in the processing job (step S115). That is, the processor 20a analyzes, with template matching, the image included in the processing job and determines whether any one of predetermined instruction images (icons included in the list L of the receipt application 10a2) is included in the image. When an instruction image is included, the processor 20a acquires a position of the instruction image in the image and an operation instruction indicated by the instruction image and deletes the instruction image from the image.

Specifically, when detecting the frame i0 (see the image in the editing region A1 shown in FIG. 5) in the image of the processing job, the processor 20a regards a region in the frame i0 as a printing range. For example, when detecting the drawer icon i5 in the image, the processor 20a discriminates timing for opening the cash drawer from a positional relation with the frame i0 indicating the printing range. In this example, since the drawer icon i5 is arranged on the outer side of the upper end of the frame i0, the processor 20a acquires an operation instruction to open the cash drawer before the content in the frame i0 is printed.

When detecting that the logo insertion icon i10 is included in the image, the processor 20a acquires an operation instruction to delete the logo insertion icon i10 from the region where the logo insertion icon i10 is arranged in the frame i0 and acquire the logo image data 20c3 indicated by the logo insertion icon i10 from the nonvolatile memory 10c and arrange the logo image data 20c3 instead of the logo insertion icon i10.

In this embodiment, when detecting the inside of the frame i2 indicating the variable section, the processor 20a determines that the image included in the processing job is an image including the variable section, that is, an image for a template. When an instruction image is arranged in the variable section, the processor 20a acquires the position of the instruction image and a row (or a region) to be instructed by the instruction image. In the case of the example shown in FIG. 5, the processor 20a acquires an operation instruction to subject characters in the frame i2 to OCR conversion and replace the characters with the font data 20c1 incorporated in the printer 20 and deletes the OCR icon i11. The processor 20a acquires an operation instruction to convert characters in a row including a character string “Total” into bold characters and deletes the bold character icon i60. Further, the processor 20a deletes the character stings in the frame i2 (because the characters in the variable section are samples in the image for the template and an image to be inserted into the variable section and actually printed is generated based on purchase data acquired every time).

Further, when detecting the scissors icon i3 in the image, the processor 20a acquires an operation instruction to cut the roll paper in a position corresponding to the position in the frame i0 where the scissors icon i3 is arranged and deletes the scissors icon i3 from the image. When detecting the icon i7 indicating that characters and images are printed thick, the processor 20a acquires an operation instruction to print characters and images thick in a region where the icon i7 is arranged (in this example, a region further on the lower side than the scissors icon i3 in the frame i0) and deletes the icon i7 from the image.

When detecting a barcode image in the image, the processor 20a decodes a barcode and acquires data included in the barcode. When content included in the barcode does not correspond to a control command for the printer 20, the processor 20a determines that the barcode is a printing target image and leaves the barcode image in the image as it is without deleting the barcode image.

When detecting the buzzer icon i4 in the image, the processor 20a acquires timing for sounding the buzzer from a positional relation between the buzzer icon i4 and the frame i0. In this example, since the buzzer icon i4 is arranged below the lower end of the frame i0, the processor 20a acquires an operation instruction to sound the buzzer after printing of the inside of the frame i0 is completed.

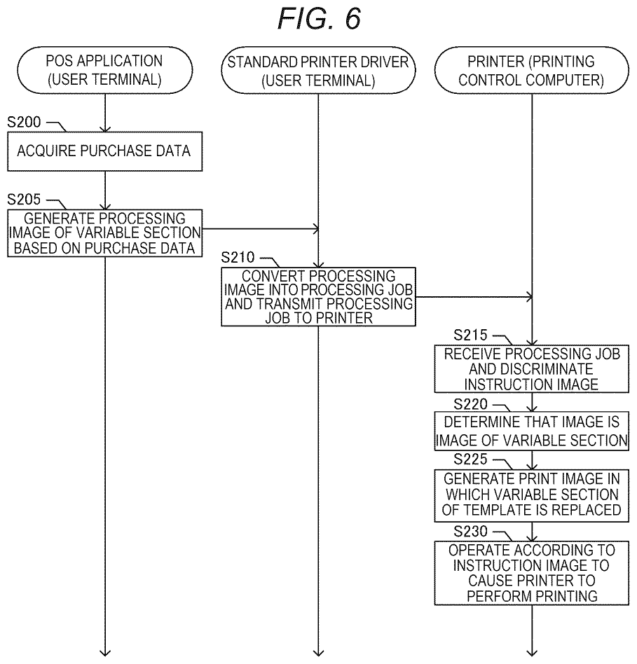

As explained above, in step S115, the processor 20a of the printer 20 discriminates the instruction image from the image of the processing job. When it is discriminated as a result of the processing in step S115 that the frame i2 is included in the image, in this embodiment, the processor 20a determines that the image is an image of a template (step S120) and registers the image in the nonvolatile memory 20c as the template data 20c2 without performing printing (step S125). Note that whether the image is the image of the template may be determined according to whether another instruction image indicating that the image is the image of the template is included in the image of the processing job. It may be determined that the image is the image of the template when at least any one of the instruction images is included in the image. The template data 20c2 is data including the image in the frame i0, the instruction image (including frame lines of the frame i0 and the frame i2) being deleted from the image, operation instructions in positions (or ranges) corresponding to positions where the instruction images are arranged in the frame i0, and operation instructions at timings corresponding to positions where the instruction images are arranged outside the frame i0. Consequently, thereafter, by receiving the processing job for only the variable section, it is possible to replace the variable section of the template and print content including the regular section and the variable section. This is specifically explained with reference to FIG. 6.

### (2-2) Printing Sequence

FIG. 6 is a sequence for executing printing after the template is registered in the printer 20. After the template registration, when the processor 10a of the user terminal 10, which executes the POS application 10a3, acquires purchase data (step S200), the processor 10a generates a processing image of the variable section based on the purchase data (step S205). In step S200, for example, in this embodiment, when a barcode or the like of a commodity is read by the handy scanner connected to the printer 20, purchase data including a purchased commodity, the number of items, and the like is transmitted to the user terminal 10. The processor 10a, which executes the POS application 10a3, acquires the purchase data. The processor 10a, which executes the POS application 10a3, extracts items to be printed on a receipt from the acquired purchase data and arranges character strings indicating the items according to a predetermined layout in the variable section to generate a processing image arranged in the variable section.

In this embodiment, as shown in FIG. 5, the operation instruction to change the format of the characters in the row having the character string “Total” in the variable section is included in template data 20a2 already registered. Therefore, the processing image created in step S205 is generated while including characters “Total”. Since the number of rows of the variable section can change according to the number of items or the like included in the purchase data, the length of the variable section in a roll paper conveying direction can also change every time. Therefore, the length of a region equivalent to the frame i0 in the roll paper conveying direction can also change. When the processing image in the variable section is generated in this way, the processor 10a, which executes the POS application 10a3, delivers the processing image to the standard printer driver 10a1.

The processor 10a, which executes the standard printer driver 10a1, converts the processing image into a processing job and transmits the processing job to the printer 20 (step S210). That is, the processor 10a converts the processing image with rendering, generates a processing job including the converted processing image and printing setting and outputs the processing job to the printer 20 via the communication unit 10b.

When the printer 20 receives the processing job via the communication unit 20b, the processor 20a discriminates an instruction image (step S215). That is, the same processing as step S115 is performed. In the case of this embodiment, since an instruction image is not included in the processing image of only the variable section, an instruction image is not detected in step S215. When an instruction image is not included in the image of the processing job, the processor 20a determines that the image is an image of the variable section (step S220). That is, the processor 20a determines that the image is an image for replacing the variable section of the template data 20c2 already registered. Note that, in the other embodiments, for example, a base image indicating into which variable section of template data already registered the image is inserted may be included also in the processing image of the variable section. In this case, it may be possible to associate the processing image and the variable section of the template data based on the instruction image.

Subsequently, the processor 20a generates a print image in which the variable section of the registered template is replaced (step S225). That is, the processor 20a generates a print image of the entire inside of the frame i0 in which the inside of the frame i2 of the registered template is replaced with the image of the processing job received in step S215. Naturally, the print image is generated in a state in which an operation instruction (including an operation instruction corresponding to the inside of the frame i2) concerning generation of a print image associated with a position in the frame i0. That is, in the case of the example shown in FIG. 5, the logo image data 20c3 is arranged in the position of i10, the items based on the purchase data are inserted into the frame i2, the characters in the frame i2 are subjected to OCR conversion and replaced with the font data 20c1, and the print image in which the image of the characters in the row including the characters “Total” in the frame i2 is converted into the image of the bold characters is generated.

Subsequently, the processor 20a operates according to the instruction image and causes the printer 20 to perform printing (step S230). That is, based on the template data 20c2, when there is an operation instruction for an operation to be performed at timing before a printing start, the processor 20a performs the operation conforming to the operation instruction. Specifically, in the case of the example shown in FIG. 5, the processor 20a opens the cash drawer. After performing the operation before the printing start, the processor 20a starts printing of the print image generated in step S225. After printing of a row immediately before the position corresponding to the scissors icon i3 ends, when a position corresponding to the scissors icon i3 on the roll paper is conveyed to a cutting unit, the processor 20a causes the cutting unit to cut the roll paper. Further, the processor 20a sets printing concentration of characters and a barcode in a region following the arrangement position of the scissors icon i3 higher than a default value and performs printing. When conveying the roll paper to a position corresponding to the lower end of the frame i0, the processor 20a sounds the buzzer.

As explained above, an instruction of a printer-specific function is converted into the format of the image to be processed by the standard printing function included in the standard printer driver. According to this embodiment explained above, even if printing is performed using the standard printer driver of the OS, it is possible to perform printing that makes use of a printer-specific function other than the standard printing function included in the standard printer driver.

### (3) Other Embodiments

The embodiment explained above is an example for carrying out the present disclosure. Other various embodiments can be adopted. For example, in the embodiment, the generation computer and the conversion computer are implemented by the same device. However, the generation computer and the conversion computer may be implemented by separate devices. The device used for editing a template and the device used as the POS terminal may be implemented by separate devices. The POS terminal may be connected to a not-shown POS server and purchase data, commodity stock data, and the like may be managed by the POS server.

In the embodiment, it is assumed that the printer-specific printer driver is not installed in the user terminal. However, the method of the present disclosure can be used, for example, when the user desires to instruct printing by a printer from a remote place using an IPP even if the printer-specific printer driver is installed.

In the embodiment, an example is explained in which the instruction image is not included in the processing image of only the variable section of the content and the processing image is generated by only the character string. However, the processing image of only the variable section may include the instruction image to generate.

A method other than the method of using the receipt application explained in the embodiment may be adopted. For example, when the user has already constructed a user-specific application (for example, a POS application) using an SDK of the printer 20 and has transmitted a printer control command to the printer 20 using a printer-specific driver program so far, a method explained below may be adopted without using the receipt application anew as explained in the embodiment. That is, the constructed user application is used as it is and functions explained below are imparted to the SDK to update the SDK. A function of converting a printer control command into a two-dimensional code and rendering the generated two-dimensional code (indicating a printer control command) with the standard driver program and outputting the two-dimensional code to the printer is imparted to a new SDK. A function of not directly printing an image of a received two-dimensional code but decoding the two-dimensional code and acquiring content encoded in the two-dimensional code is imparted to the printer side. When content encoded in a two-dimensional code image transmitted together with a print image is a printer control command, the printer controls the printer itself according to the command and performs printing. Since the SDK and the program of the printer side are updated in this way, the user can output a printer-specific command to the printer using the standard driver program without using the printer-specific driver program and control the printer according to the command while keeping on using the already constructed application. Therefore, for example, when the user desires to control the printer using the IPP from a remote place, the user can control the printer.

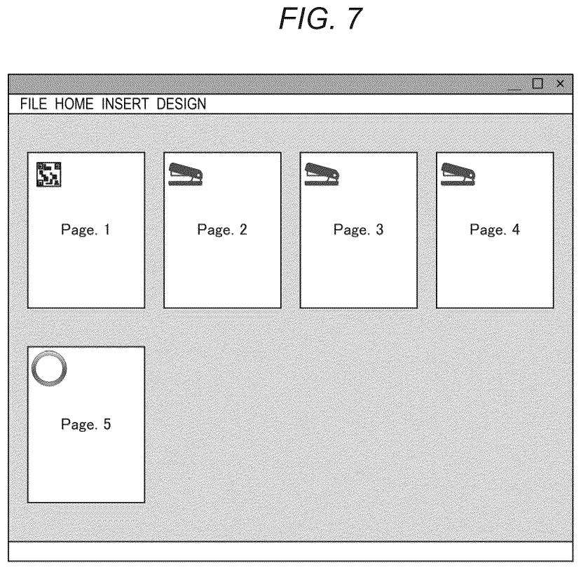

Further, in the embodiment, the receipt printer is explained as an example. However, an operation instruction may be output to a printer other than the receipt printer, for example, a document printer in a high price range having a finisher function through the standard printer driver. For example, a case in which a document including five pages as shown in FIG. 7 is created by a document creation application is explained. In FIG. 7, print images such as character strings and images in pages are not shown and page numbers are described. In the case of printing of a document including a plurality of pages, for example, a printing instruction may be able to be performed using the standard printer driver in a state in which instruction images shown in FIG. 7 are inserted into pages. A staple icon at the upper left in second to forth pages is an example of an instruction image indicating an operation instruction to staple the upper left of the second to fourth pages. An icon at the upper left of a fifth page is an example of an instruction image indicating an operation instruction to print only the fifth page in color. A first page includes a two-dimensional code (an instruction image) obtained by encoding data indicating that, since an instruction image for the printer is included in this document, the instruction image is analyzed and an operation instruction indicated by the instruction image is performed to print the document. These instruction images are provided on the Internet in advance by the vendor of the printer. The user can download the instruction images from the Interne and insert the instruction image into a document.

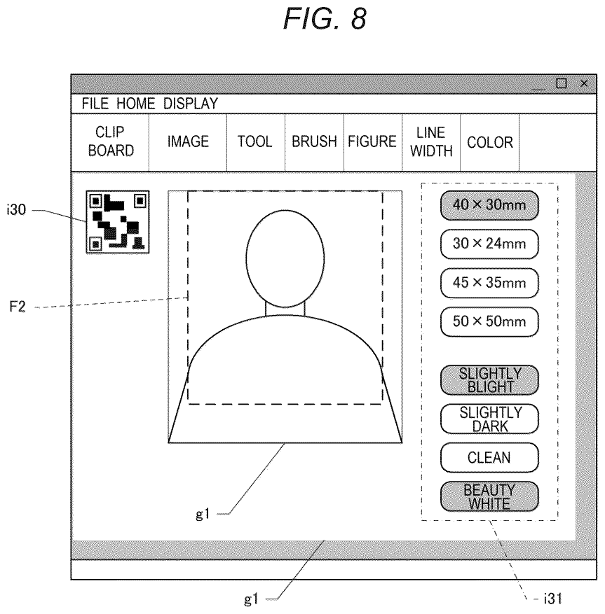

For example, when the user desires to print a photograph to be pasted to a certificate with a printer for home use, since it is difficult to print the photograph in a designated size such as 3 cm×4 cm, the user may generate a processing image obtained by adding an instruction image to the outer side of a photograph image desired to be printed and perform printing through the standard printer driver. FIG. 8 is an example of a screen of an image editing application. The user arranges a portrait photograph g1 for a certificate photograph in an image g0 on white paper of an editing screen of the image editing application. The user downloads an instruction image i30 and an instruction image group i31 for certificate photograph printing provided by the vendor of the printer on the Internet and arranges the instruction image i30 and the instruction image group i31 on the outer side of the portrait photograph g1 in the image g0. The user designates, in the image g0, with a rectangular frame F2, a region desired to be excluded from a printing range of the certificate photograph and a region that does not have to be excluded. In the example shown in FIG. 8, the frame F2 is set on the inner side of the portrait photograph g1. However, the frame F2 may be set on the boundary of the portrait photograph g1. The instruction image i30 is a two-dimensional code encoded to indicate that an image of the frame F2 serving as an instruction image is printed according to an operation instruction indicated by a selected instruction image among the instruction image group i31. The instruction image group i31 is an image in which character strings indicating operation instructions are arranged in a plurality of frames simulating buttons. A default value of background colors in the frames is white. The user selects an operation instruction by painting out a frame corresponding to an operation instruction desired to be selected in a color other than white with a painting tool for the background colors. The example shown in FIG. 8 indicates that “40×30 mm” is selected as a finish size of the certificate photograph and “slightly bright” and “beauty white” are selected as content of image processing for a portrait photograph. The user edits the image g0, for example, as explained above and instructs the printer to print the image g0 using the standard printer driver. The image g0 is converted into a processing job by the standard printer driver and output to the printer. The printer receiving the processing job analyzes an image included in the processing job and discriminates the operation instruction. Specifically, the printer clips the image in the frame F2 in a maximum size with an aspect ratio of 4×3, applies image processing indicated by the selected instruction image to the clipped image, performs resolution conversion to set the size of the portrait photograph to 40 mm×30 mm, and performs printing.

Note that a function of adding an instruction image may be able to be used as plug-in to an application for editing an image to be printed by a large format printer for printing a poster or the like. The instruction image may be a two-dimensional code obtained by encoding data indicating a color profile in an editing work environment. Specifically, for example, a color conversion table for converting a color space (sRGB) of a monitor used for editing into an Lab color space is encoded into a two-dimensional code. When the user instructs the printer to print an image including such a two-dimensional code using the standard printer driver, the printer decodes the two-dimensional code to acquire an LUT, converts the image into Lab, further converts the image from Lab into CMYK using a color conversion table stored in the printer, and performs printing. In this way, data for color matching may be able to be added to the outside of a printing range of the image as the instruction image.

In the embodiment explained above, in the receipt application and other various applications, the user uses and arranges an instruction image prepared in advance in an application or an instruction image disclosed on the Internet by the vendor of the printer to thereby designate content of an operation instruction and timing for implementing the operation instruction. However, the instruction image corresponding to the operation instruction is not limited to be an image prepared and determined in advance. For example, the user may be able to designate the content of the operation instruction and the timing for implementing the operation instruction by creating and arranging a character string indicating the operation instruction. For example, any image indicating the operation instruction may be used. The printing control computer may be configured to be able to determine content of an operation instruction indicated by the image using a machine learning model.

In the present disclosure, the printer driver is not limited to the standard printer driver of the OS and may be a printer driver manufactured by anybody for any purpose. Even in that case, when the printer driver is not adapted to a part of functions of the printer, it is possible to enable printing in which the functions are used.

In the present disclosure, the generation to the printing of the processing image may not be continuously performed by, for example, generating the processing image in advance, giving the processing image to the printer driver at timing when a print is necessary, and causing the printer to perform printing. Further, a plurality of times of printing may be performed using one processing image generated in advance. In such a case, as the printer driver, either a printer driver adapted to all the functions of the printer or a printer driver adapted to not all the functions of the printer can be used.

Further, the present disclosure is also applicable as a program and a method to be executed by a computer. For example, the preset disclosure is established as an invention of a processing image production method including: receiving a print image to be printed and an operation instruction; and generating a processing image obtained by adding an instruction image corresponding to the operation instruction to the print image.

The present disclosure is also established as an invention of a processing image production program for causing a computer to function as: a receiving unit configured to receive a print image to be printed and an operation instruction; and a generating unit configured to generate a processing image obtained by adding an instruction image corresponding to the operation instruction to the print image. For example, in the embodiment explained above, the processor 10a in executing the receipt application 10a2 functions as the receiving unit and the generating unit.

Further, the present disclosure is also established as an invention of a print generation method including: receiving a processing image obtained by adding an instruction image corresponding to an operation instruction to a print image; discriminating the instruction image from the processing image; and operating according to the operation instruction corresponding to the instruction image to cause a printing unit to print the print image.

The present disclosure also functions as an invention of a print production program for causing a computer to function as: a job receiving unit configured to receive a processing job into which a processing image obtained by adding an instruction image corresponding to an operation instruction to a print image is converted; a discriminating unit configured to discriminate the instruction image from an image included in the processing job; and a printing control unit configured to operate according to the operation instruction corresponding to the instruction image to cause a printing unit to print the print image. For example, in the embodiment explained above, the processor 20a (the printing control computer) of the printer 20 functions as the job receiving unit, the discriminating unit, and the printing control unit.

The system, the program, and the method explained above are implemented as an independent device in some cases and are implemented using components included in a plurality of devices in other cases and include various forms. The system, the program, and the method can be changed as appropriate, for example, a part thereof is software and a part thereof is hardware. Further, the present disclosure is established as a recording medium for a program for controlling the system. Naturally, the recoding medium for the program may be a magnetic recording medium or may be a semiconductor memory. All recording media to be developed in future can be considered completely the same. An application and a printer driver may be created as an integral program.

What is claimed is:

1. A printing system comprising:
a generation computer configured to receive a print image to be printed and an operation instruction and generate a processing image, which is an image obtained by adding an instruction image corresponding to the operation instruction to the print image;
a conversion computer configured to receive the processing image and convert the processing image into a processing job; and
a printing control computer configured to receive the processing job, discriminate the instruction image from an image of the processing job, and operate according to the operation instruction corresponding to the instruction image to cause a printing unit to print the print image.

2. The printing system according to claim 1, wherein the generation computer generates the processing image in which the instruction image is added to a position corresponding to the operation instruction.

3. The printing system according to claim 2, wherein the generation computer adds the instruction image to a position that the user designated with any operation such as click, tap, or drag.

4. The printing system according to claim 2, wherein the instruction image is a frame line of a predetermined type indicating a printing range.

5. The printing system according to claim 4, wherein the instruction image is a frame line indicating a range of a variable section in which a number of rows can be variable and is a frame line of a type different from the frame line indicating the printing range.

6. The printing system according to claim 2, wherein the instruction image is a barcode or a two-dimensional code.

7. The printing system according to claim 1, wherein the conversion computer does not include a function of adding, to the processing job, as a command, the operation instruction of a nonstandard type that a specific printer driver can add as a command.

8. The printing system according to claim 7, wherein the conversion computer performs the conversion with a standard printer driver included in an operating system.

9. The printing system according to claim 1, wherein the printing control computer does not cause the printing unit to print the instruction image included in the image of the processing job.

10. A processing image production method comprising:
receiving a print image to be printed and an operation instruction; and
generating a processing image obtained by adding an instruction image corresponding to the operation instruction to the print image.

11. A print production method comprising:
receiving a processing image obtained by adding an instruction image corresponding to an operation instruction to a print image;
discriminating the instruction image from the processing image; and
operating according to the operation instruction corresponding to the instruction image to cause a printing unit to print the print image.
